(19) United States
(12) Patent Application Publication
(10) Pub. No.: US 2026/0195674 A1
(43) Pub. Date: Jul. 9, 2026

(54) PUMP MAINTENANCE COORDINATOR (PMC) FOR HYDRAULIC FRACTURING OPERATIONS

(71) Applicant: Halliburton Energy Services, Inc., Houston, TX (US)

(72) Inventors: Mudiaga Ovuede, Houston, TX (US); Baidurja Ray, Houston, TX (US); Michael Thomas Gallant, Houston, TX (US); Bradley James Peschel, Houston, TX (US); Zhijie Sun, Houston, TX (US)

(73) Assignee: Halliburton Energy Services, Inc., Houston, TX (US)

(21) Appl. No.: 19/014,623

(22) Filed: Jan. 9, 2025

(51) Int. Cl. G06Q 10/0631; G06Q 10/20; G06Q 50/06

(52) U.S. Cl. CPC G06Q 10/063118; G06Q 10/20; G06Q 50/06

(57) ABSTRACT

A method for generating an optimized job schedule for a job that includes obtaining input data that includes a job schedule specifying a plurality of stages for the job, equipment data, and maintenance task data, identifying a plurality of job constraints using the input data, calculating a job profit rate using the input data, and generating the optimized job schedule using the plurality of job constraints and the job profit rate.

### BACKGROUND

The oil and gas industry may use wellbores as fluid conduits to access subterranean deposits of various fluids and minerals which may include hydrocarbons. A drilling operation may be utilized to construct the fluid conduits which are capable of producing hydrocarbons disposed in subterranean formations. Wellbores may be constructed, in increments, as tapered sections, which sequentially extend into a subterranean formation.

### BRIEF DESCRIPTION OF DRAWINGS

These drawings illustrate certain aspects of some examples of the present disclosure and should not be used to limit or define the disclosure.

FIG. 1A is a diagram of an example fracturing environment.

FIG. 1B is a diagram of an example fracturing environment showing multiple tanks and pumps.

FIG. 1C is a diagram of an example computing environment.

FIG. 2A is a diagram of a schedule optimizer and various data components in relation to information handling system.

FIG. 2B is a diagram of personnel data and other data components therein.

FIG. 2C is a diagram of maintenance task data and other data components therein.

FIG. 2D is a diagram of equipment data and other data components therein.

FIG. 2E is a diagram of stage data and other data components therein.

FIG. 2F is a diagram of a job schedule and other data components therein.

FIG. 3A is a diagram of job constraints, job profit rate, and other data components therein.

FIG. 3B is a flowchart of a method for generating an optimized job schedule.

FIG. 4 is a flowchart of a method for generating an optimized job schedule.

FIG. 5A is a diagram of an example unoptimized job schedule, with corresponding monetary values.

FIG. 5B is a diagram of an example optimized job schedule, with corresponding monetary values.

### DETAILED DESCRIPTION

### Overview and Advantages

In general, this application discloses one or more embodiments of methods and systems for generating an optimized job schedule. Specifically, in one or more embodiments, a schedule optimizer (e.g., executing as software) may be provided an unoptimized job schedule as an input, query relevant data, calculate associated costs for each action, and produce an optimized job schedule that maximizes a profit rate for the desired stages. Accordingly, when using such a system, human input into the creation of the job schedule is reduced, thereby removing some sources of potential error and oversight in the planning and execution of the job schedule.

Conventionally, one or more individuals (e.g., a site supervisor, an operations manager, etc.) manually generate a job schedule for a series of stages to be performed on a wellbore. Such stages may require the use of a multitude of equipment to perform the individual actions of the stage. In turn, that equipment often requires maintenance to replenish or replace consumable and/or damaged components. Accordingly, when generating the job schedule, those individuals are tasked with using their expertise and intuition to predict and plan the sequential and concurrent maintenance required (for the equipment) to complete the stages. As there is human input into the process, there is always the possibility of mistakes and oversights. Even a satisfactory job schedule (produced by an experienced and competent individual) will lack consistency with a job schedule produced by another qualified individuals. Further, such job schedules, although sufficient, may prioritize too much of an unimportant attribute—for example, minimizing overall duration by performing premature maintenance and generating costly waste.

As a non-limiting example, a valve on a pump may be required to be replaced after a threshold of volumetric flow goes through the valve (e.g., the valve must be replaced after one million gallons (3,785 m³) of use). In turn, if a valve is nearing the end of its usable life (e.g., 80%) and the pump is scheduled for a stage that will cause the valve to exceed that life, the stage would have to be interrupted to replace the valve—costing time for maintenance and losing time for production. Accordingly, it may be desirable to pre-emptively replace the valve in order to not interrupt the stage—even though there is 20% remaining life on the valve. However, in such an instance, the valve will likely be scrapped, as there is likely no profit is reinstalling the valve elsewhere (costing time) to use the remaining 20% of its life before needing to be replaced again (costing more time). As there may be hundreds of components for dozens of pieces of equipment, it may require significant effort (for a human) to generate an optimized job schedule that correctly accounts for every variable. Further, even if a human could generate an optimized job schedule, various unexpected events are likely to occur during the job that will require modifications to job schedule, therefore requiring the job schedule to be re-optimized based on the new data.

As disclosed in one or more embodiments herein, a schedule optimizer may be used to gather data from available sources (e.g., personnel, equipment, maintenance, stages, etc.) and optimize (or newly create) a job schedule that prioritizes a specific preferred attribute (e.g., profit rate). To accomplish this, the schedule optimizer may use the available data to (i) identify job constraints and (ii) calculate a job profit rate, then maximize the job profit rate while complying with the job constraints. For any job schedule, there may be dozens of job constraints at any time during a job, while hundreds of factors may need to be considered to maximize the job profit rate, including, for example, projecting component usage, predicting maintenance tasks, identifying which tasks may be concurrent or sequential, the effect of performing any task on other tasks and stages (i.e., inter-dependency), and every related constraint. Accordingly, the schedule optimizer is able to consider all of the relevant data to generate an optimized job schedule that accounts for each relevant factor. Further, if an unexpected event occurs during the job (e.g., a component breaks prematurely), the relevant data can be updated (e.g., in the equipment data) and the schedule optimizer may be used to generate a new optimized job schedule, provided with the new constraints of the equipment data.

Continuing with the previous example (a valve with 20% remaining life), the schedule optimizer may calculate—based on optimizing profit rate—that either of the two conventional options are appropriate (i) the pump should be used, even though the stage will be interrupted, or (ii) that the valve should be replaced pre-emptively. However, the schedule optimizer may also identify and schedule another solution which requires greater complexity and inter-dependency. For example, the schedule optimizer may determine that the pump should not be used for the planned stage at all, but instead should be used for a different, less-demanding stage (with a lower overall volumetric flow)—allowing for the remaining value of the valve to be used and the pump to complete the stage without interruption. As another example, the schedule optimizer may determine that the pump should be used for the selected stage, but that upon surpassing the valve's usable threshold, another pump (on standby) can be activated while the expired-valve pump is taken offline for maintenance (to replace the valve). As such, the stage is not interrupted, and concurrent maintenance may be performed.

Accordingly, by using a schedule optimizer, an efficient ordering of stages and maintenance tasks may be generated in an optimized job schedule. Further, as the schedule optimizer maintains access to continually updated data, the job schedule may be dynamically adjusted and optimized as stages and maintenance are performed. Thus, even when stages and maintenance are not completed as planned, the job can still continue to maintain an optimized ordering of stages and maintenance tasks.

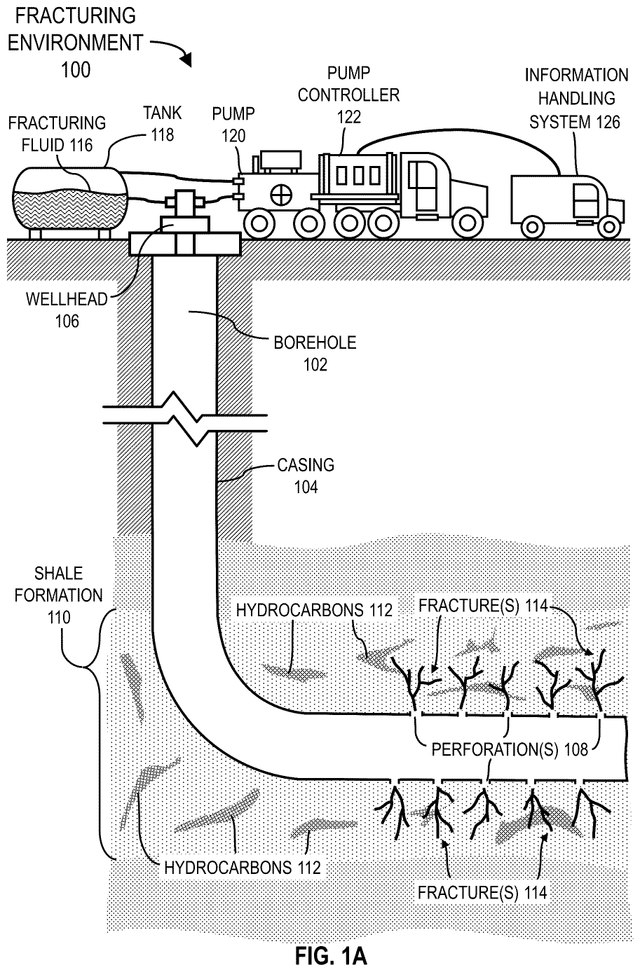

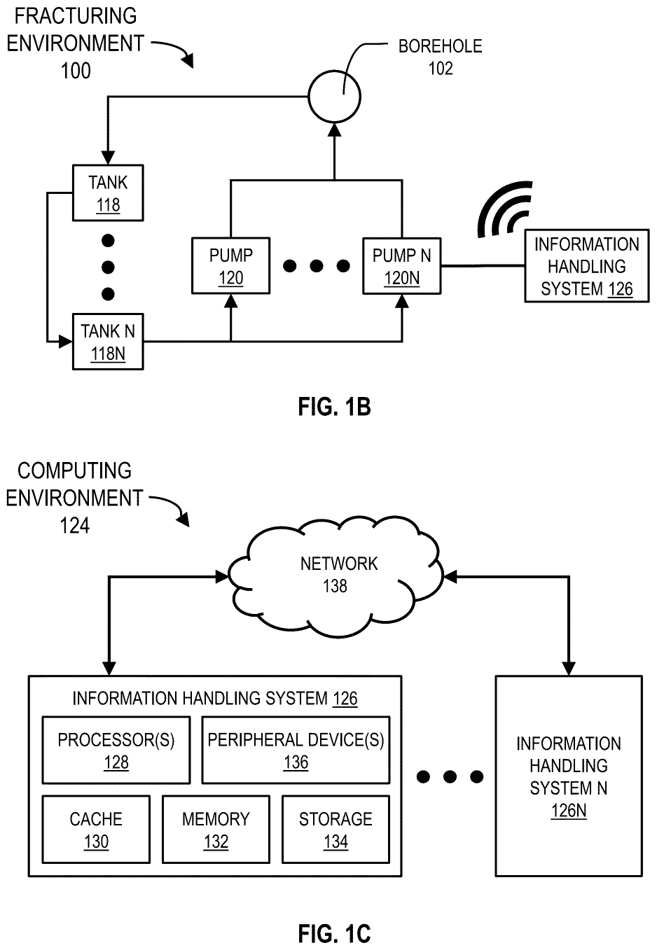

### FIGS. 1A-1C

FIG. 1A is a diagram of an example fracturing environment. FIG. 1B is a diagram of an example fracturing environment showing multiple tanks and pumps. FIG. 1C is a diagram of an example computing environment.

Fracturing environment 100 may include one or more pump(s) 120 (controlled by one or more pump controller(s) 122) that pump fracturing fluid 116 into borehole 102 (through wellhead 106) to extract hydrocarbons 112 from shale formation 110 via fracture(s) 114. Each of these components is described below.

Borehole 102 is a hole in the ground which may be formed by a drillstring (and one or more components thereof) to access subterranean resource deposits. Borehole 102 may be partially or fully lined with casing 104. Further, wellhead 106 may be installed between the surface and borehole 102 to provide control and separation of the contents of borehole 102.

Casing 104 is concrete and/or metal lining that separates borehole 102 from the surrounding ground. Casing 104 may be used to protect the surrounding ground from the contents of borehole 102, and conversely, to protect borehole 102 from the surrounding ground. In fracturing environment 100, casing 104 may be constructed to withstand pressures greater than casings 104 installed in a drilling environment.

Wellhead 106 is a machine which may include one or more pipes, caps, and/or valves to provide pressure control for contents within borehole 102. In any embodiment, wellhead 106 may be equipped with a blowout preventer (not shown) to prevent the flow of higher-pressure fluids (in borehole 102) from escaping to the surface in an uncontrolled manner. Wellhead 106 may be equipped with other ports and/or sensors to monitor pressures within borehole 102 and/or otherwise facilitate drilling and/or fracturing operations.

Perforations 108 are small holes created in casing 104 to allow fracturing fluid 116 to flow into shale formation 110. In any embodiment, perforations 108 may be created by a perforating gun (not shown) and/or other machine to puncture the walls of casing 104. Perforations 108 may be made in any direction in shale formation 110 that allows for the extraction of hydrocarbons 112.

Shale formation 110 is a sedimentary rock layer which is composed of mud, silt, and clay. Shale formation 110 may be formed when layers of mud and silt are deposited in the earth, oceans, lakes, and/or rivers. Over time, the weight of the overlying sediment compresses the mud and silt, forming shale. Shale formation 110 is often found in layers, with other sedimentary rocks, such as sandstone and limestone. Shale formation 110 is typically very thin, ranging from a few inches to a few feet in thickness. However, shale formation 110 may be thicker, with some formations reaching thicknesses of over 1,000 feet. In any embodiment, Shale formation 110 may be a source of hydrocarbons 112.

Hydrocarbons 112 are a resource (e.g., oil and/or natural gas) formed from organic matter within shale formation 110. Hydrocarbons 112 may be dispersed within shale formation 110 and not easily accessible. Consequently, extracting hydrocarbons 112 from shale formation 110 may be achieved via hydraulic fracturing (e.g., through fracture(s) 114 created in shale formation 110).

Fracture 114 is a planar crack in shale formation 110 which is created by pumping fracturing fluid 116 into shale formation 110 at high pressure. Fracture 114 begins at perforation 108 (through casing 104 of borehole 102). Fracture 114 may be several hundred feet long and several inches wide. They can also be complex, with multiple branches and extensions.

Fracturing fluid 116 is a mixture of liquid(s) and/or solids which may be pumped through borehole 102 to create fracture(s) 114 and collect hydrocarbons 112. In any embodiment, fracturing fluid 116 is typically a mixture of water, proppant, and chemical additives. Water in fracturing fluid 116 may be used to transmit the pressure to shale formation 110 and create fracture(s) 114. A proppant (e.g., sand, ceramic beads) keeps fracture(s) 114 open after fracturing fluid 116 is withdrawn from borehole 102. Chemical additives may be used to improve the performance of fracturing fluid 116 by reducing friction and preventing loss of viscosity. In any embodiment, fracturing fluid 116 is pumped (i.e., via pump(s) 120) down borehole 102 and through perforation(s) of casing 104 into shale formation 110. The pressure created by fracturing fluid 116 exceeds the tensile strength of the rocks in shale formation 110, causing the rocks to split and create fracture(s) 114. Consequently, fracturing fluid 116 is forced into fracture(s) 114, and the proppant keeps fracture(s) 114 open after fracturing fluid 116 is withdrawn.

Tank 118 is a vessel which may be used to store (or otherwise contain) fracturing fluid 116. In one or more embodiments, there may be one or more tanks 118 designated for distinct types of fracturing fluid 116 and/or fracturing fluid 116 at various stages of treatment. Tanks 118 may be connected in series and/or in parallel depending on the needs of the operations performed in the fracturing environment 100.

Pump 120 is a machine that may be used to circulate fracturing fluid 116 from a tank to the interior of borehole 102 (e.g., through one or more port(s) on wellhead 106). Pump 120 may be of any type (e.g., centrifugal, gear, etc.) and powered by any suitable means (e.g., electricity, combustible fuel, etc.). In any embodiment, pump(s) 120 may be connected to pump controller(s) 122 which, in turn, operatively connect to information handling system 126. In such a configuration, information handling system 126 may control pump(s) 120 (e.g., initiate powering off, powering on, throttling, etc.) via pump controller(s) 122. In any embodiment, pump 120 may be mounted and transported on an automotive vehicle (e.g., a truck) for transportation to and from fracturing environment 100.

Pump controller 122 is a hardware computing device that may control one or more pump(s) 120. In any embodiment, pump controller 122 may control the flow of electrical power (e.g., voltage, current) to pump(s) 120 and/or control the flow of fuel (e.g., via a choke, any valve) to pump(s) 120. In turn, pump controller 122 may control the rotational speed, torque, power, torque, and/or flow rate of pump(s) 120.

Computing environment 124 may include one or more information handling system(s) 126 connected via network 138. Each of these components is described below.

Information handling system 126 is a hardware computing device which may be utilized to perform various steps, methods, and techniques disclosed herein (e.g., via the execution of software). In any embodiment, information handling system 126 may include one or more processors 128, cache 130, memory 132, storage 134, and/or one or more peripheral device(s) 136. Any two or more of these components may be operatively connected via a system bus (not shown) that provides a means for transferring data between those components. Although each component is depicted and disclosed as individual functional components, these individual components may be combined (or divided) into any combination or configuration of components. Information handling system 126 may be operatively connected to pump controller(s) 122 (and/or other various components of fracturing environment 100). In any embodiment, information handling system 126 may utilize any suitable form of wired and/or wireless communication to send and/or receive data to and/or from other components of fracturing environment 100 (e.g., to control one or more pump(s) 120 via pump controller(s) 122). In any embodiment, information handling system 126 may receive a digital telemetry signal, demodulate the signal, display data (e.g., via a visual output device), and/or store the data.

A system bus is a system of hardware connections (e.g., sockets, ports, wiring, conductive tracings on a printed circuit board (PCB), etc.) used for sending (and receiving) data to (and from) each of the components connected thereto. In any embodiment, a system bus allows for communication via an interface and protocol (e.g., inter-integrated circuit (I2C), peripheral component interconnect (express) (PCI(e)) fabric, etc.) that may be commonly recognized by the components utilizing the system bus. In any embodiment, a basic input/output system (BIOS) may be configured to transfer information between the components using the system bus (e.g., during initialization of information handling system 126).

In any embodiment, information handling system 126 may additionally include internal physical interface(s) (e.g., serial advanced technology attachment (SATA) ports, peripheral component interconnect (PCI) ports, PCI express (PCIe) ports, next generation form factor (NGFF) ports, M.2 ports, etc.) and/or external physical interface(s) (e.g., universal serial bus (USB) ports, recommended standard (RS) serial ports, audio/visual ports, etc.). Internal physical interface(s) and external physical interface(s) may facilitate the operative connection to one or more peripheral device(s) 136.

Non-limiting examples of information handling system 126 include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device with the aforementioned capabilities. Further, information handling system 126 may be operatively connected to another information handling system 126 via network 138 in a distributed computing environment. As used herein, a “computing device” may be equivalent to an information handling system.

Processor 128 is a hardware device which may take the form of an integrated circuit configured to process computer-executable instructions (e.g., software). Processor 128 may execute (e.g., read and process) computer-executable instructions stored in cache 130, memory 132, and/or storage 134. Processor 128 may be a self-contained computing system, including a system bus, memory, cache, and/or any other components of a computing device. Processor 128 may include multiple processors, such as a system having multiple, physically separate processors in different sockets, or a system having multiple processor cores on a single physical chip. A multi-core processor may be symmetric or asymmetric. Multiple processors 128, and/or processor cores thereof, may share resources (e.g., cache 130, memory 132) or may operate using independent resources.

Non-limiting examples of processor 128 include general-purpose processor (e.g., a central processing unit (CPU)), an application specific integrated circuit (ASIC), a programmable gate array (PGA), a field programmable gate array (FPGA), a digital signal processor (DSP), and any digital or analog circuit configured to perform operations based on input data (e.g., execute program instructions).

Cache 130 is one or more hardware device(s) capable of storing digital information (e.g., data) in a non-transitory medium. Cache 130 expressly excludes transitory media (e.g., transitory waves, energy, carrier signals, electromagnetic waves, signals per se, etc.). Cache 130 may be considered “high-speed”, having comparatively faster read/write access than memory 132 and storage 134, and therefore utilized by processor 128 to process data more quickly than data stored in memory 132 or storage 134. Accordingly, processor 128 may copy needed data to cache 130 (from memory 132 and/or storage 134) for comparatively speedier access when processing that data. In any embodiment, cache 130 may be included in processor 128 (e.g., as a subcomponent). In any embodiment, cache 130 may be physically independent, but operatively connected to processor 128.

Memory 132 is one or more hardware device(s) capable of storing digital information (e.g., data) in a non-transitory medium. Memory 132 expressly excludes transitory media (e.g., transitory waves, energy, carrier signals, electromagnetic waves, signals per se, etc.). In any embodiment, when accessing memory 132, software (executed via processor 128) may be capable of reading and writing data at the smallest units of data normally accessible (e.g., “bytes”). Specifically, memory 132 may include a unique physical address for each byte stored thereon, thereby enabling the ability to access and manipulate (read and write) data by directing commands to a specific physical address associated with a byte of data (i.e., “random access”). Non-limiting examples of memory 132 devices include flash memory, random access memory (RAM), dynamic RAM (DRAM), static RAM (SRAM), resistive RAM (ReRAM), read-only memory (ROM), and electrically erasable programmable ROM (EEPROM). In any embodiment, memory 132 devices may be volatile or non-volatile.

Storage 134 is one or more hardware device(s) capable of storing digital information (e.g., data) in a non-transitory medium. Storage 134 expressly excludes transitory media (e.g., transitory waves, energy, carrier signals, electromagnetic waves, signals per se, etc.). In any embodiment, the smallest unit of data readable from storage 134 may be a “block” (instead of a “byte”). Prior to reading and/or manipulating the data on storage 134, one or more block(s) may be copied to an intermediary storage medium (e.g., cache 130, memory 132) where the data may then be accessed in “bytes” (e.g., via random access). In any embodiment, data on storage 134 may be accessed in “bytes” (like memory 132). Non-limiting examples of storage 134 include integrated circuit storage devices (e.g., a solid-state drive (SSD), Non-Volatile Memory Express (NVMe), flash memory, etc.), magnetic storage devices (e.g., a hard disk drive (HDD), floppy disk, magnetic tape, diskette, cassettes, etc.), optical media (e.g., a compact disc (CD), digital versatile disc (DVD), etc.), and printed media (e.g., barcode, quick response (QR) code, punch card, etc.).

As used herein, “non-transitory computer readable medium” is cache 130, memory 132, storage 134, and/or any other hardware device capable of non-transitorily storing and/or carrying data.

Peripheral device 136 is a hardware device configured to send (and/or receive) data to (and/or from) information handling system 126 via one or more internal and/or external physical interface(s). Any peripheral device 136 may be categorized as one or more “types” of computing devices (e.g., an “input” device, “output” device, “communication” device, etc.). However, such categories are not comprehensive and are not mutually exclusive. Such categories are listed herein strictly to provide understandable groupings of the potential types of peripheral devices 136. As such, peripheral device 136 may be an input device, an output device, a communication device, and/or any other optional computing component.

An input device is a hardware device that receives data into information handling system 126. In any embodiment, an input device may be a human interface device which facilitates user interaction by collecting data based on user inputs (e.g., a mouse, keyboard, camera, microphone, touchpad, touchscreen, fingerprint reader, joystick, gamepad, etc.). In any embodiment, an input device may collect data based on raw inputs, regardless of human interaction (e.g., any sensor, logging tool, audio/video capture card, etc.). In any embodiment, an input device may be a reader for accessing data on a non-transitory computer readable medium (e.g., a CD drive, floppy disk drive, tape drive, scanner, etc.).

An output device is a hardware device that sends data from information handling system 126. In any embodiment, an output device may be a human interface device which facilitates providing data to a user (e.g., a visual display monitor, speakers, printer, status light, haptic feedback device, etc.). In any embodiment, an output device may be a writer for facilitating storage of data on a non-transitory computer readable medium (e.g., a CD drive, floppy disk drive, magnetic tape drive, printer, etc.).

A communication device is a hardware device capable of sending and/or receiving data with one or more other communication device(s) (e.g., connected to another information handling system 126 via network 138). A communication device may communicate via any suitable form of wired interface (e.g., Ethernet, fiber optic, serial communication etc.) and/or wireless interface (e.g., Wi-Fi® (Institute of Electrical and Electronics Engineers (IEEE) 802.11), Bluetooth® (IEEE 802.15.1), etc.) and utilize one or more protocol(s) for the transmission and receipt of data (e.g., transmission control protocol (TCP), user datagram protocol (UDP), internet protocol (IP), remote direct memory access (RDMA), etc.). Non-limiting examples of a communication device include a network interface card (NIC), a modem, an Ethernet card/adapter, and a Wi-Fi® card/adapter.

An optional computing component is any hardware device that operatively connects to information handling system 126 and extends the capabilities of information handling system 126. Non-limiting examples of an optional computing components include a graphics processing unit (GPU), a data processing unit (DPU), and a docking station.

As used herein, “software” (e.g., “code”, “algorithm”, “application”, “routine”) is data in the form of computer-executable instructions. Processor 128 may execute (e.g., read and process) software to perform one or more function(s). Non-limiting examples of functions may include reading existing data, modifying existing data, generating new data, and using any capability of information handling system 126 (e.g., reading existing data from memory 132, generating new data from the existing data, sending the generated data to a GPU to be displayed on a monitor). Although software physically persists in cache 130, memory 132, and/or storage 134, one or more software instances may be depicted, in the figures, as an external component of any information handling system 126 that interacts with one or more information handling system(s) 126.

Network 138 is a collection of connected information handling systems (e.g., 126, 126N) that allows for the exchange of data and/or the sharing of computing resources therebetween. Non-limiting examples of network 138 include a local area network (LAN), a wide area network (WAN) (e.g., the Internet), a mobile network, any combination thereof, and any other type of network that allows for the communication of data and sharing of resources among computing devices operatively connected thereto. A person of ordinary skill in the relevant art, having the benefit of this detailed description, would appreciate that a network is a collection of operatively connected computing devices that enables communication between those computing devices.

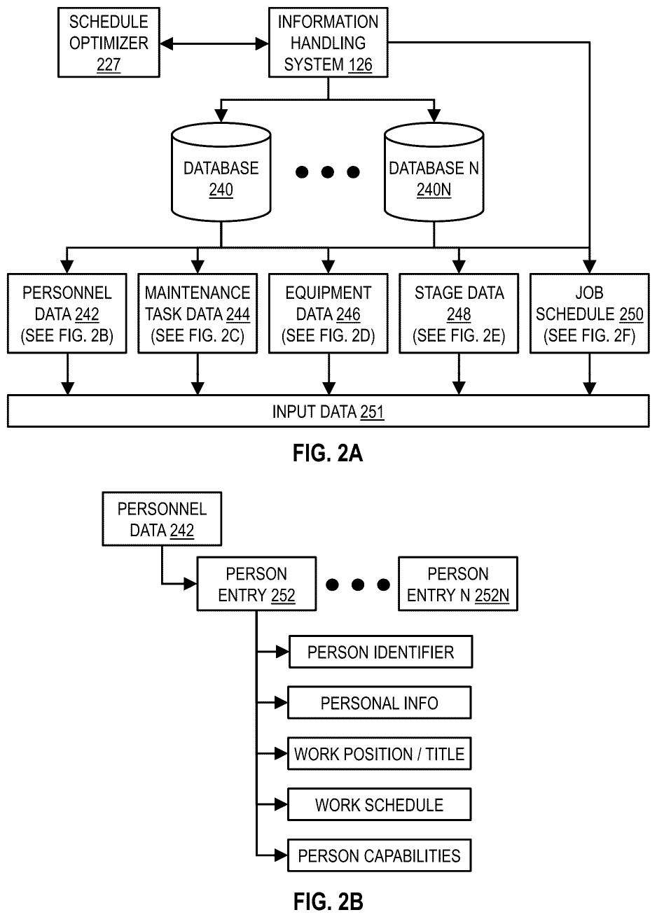

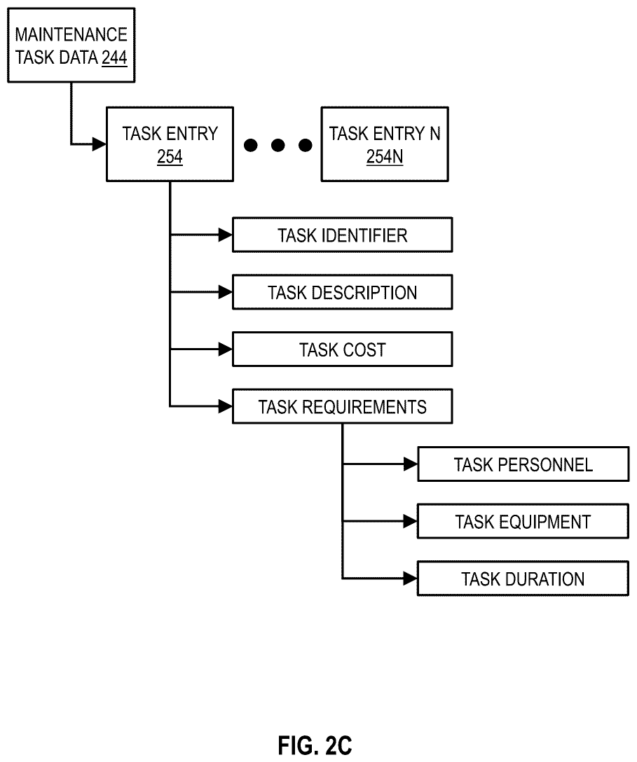

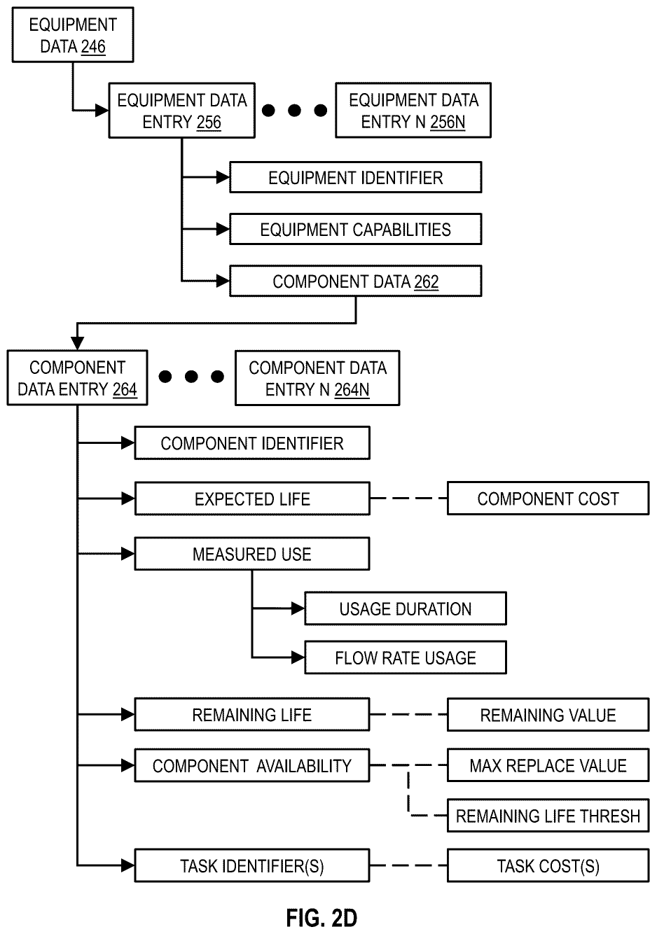

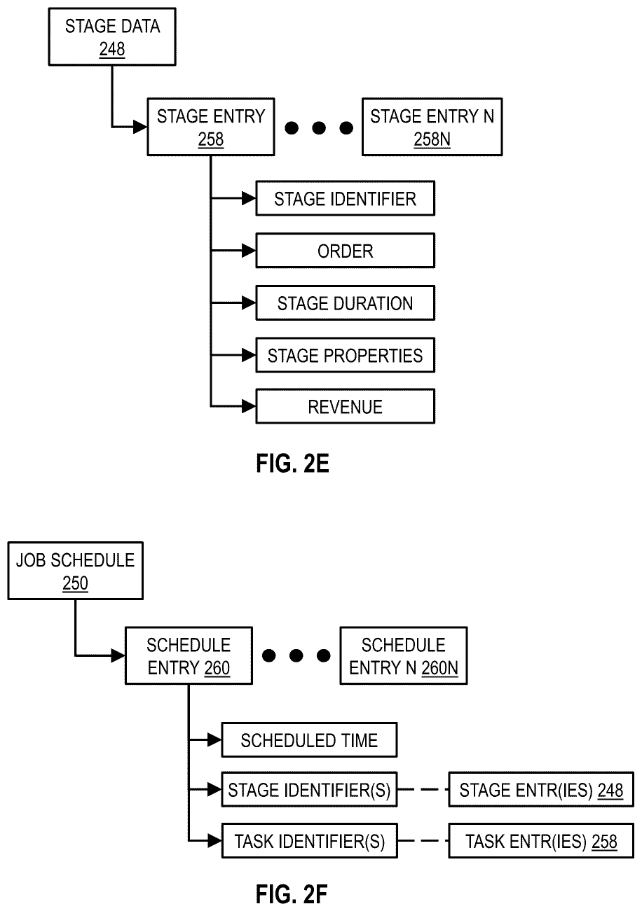

### FIGS. 2A-2F

FIG. 2A is a diagram of a schedule optimizer and various data components in relation to information handling system. FIG. 2B is a diagram of personnel data and other data components therein. FIG. 2C is a diagram of maintenance task data and other data components therein. FIG. 2D is a diagram of equipment data and other data components therein. FIG. 2E is a diagram of stage data and other data components therein. FIG. 2F is a diagram of a job schedule and other data components therein.

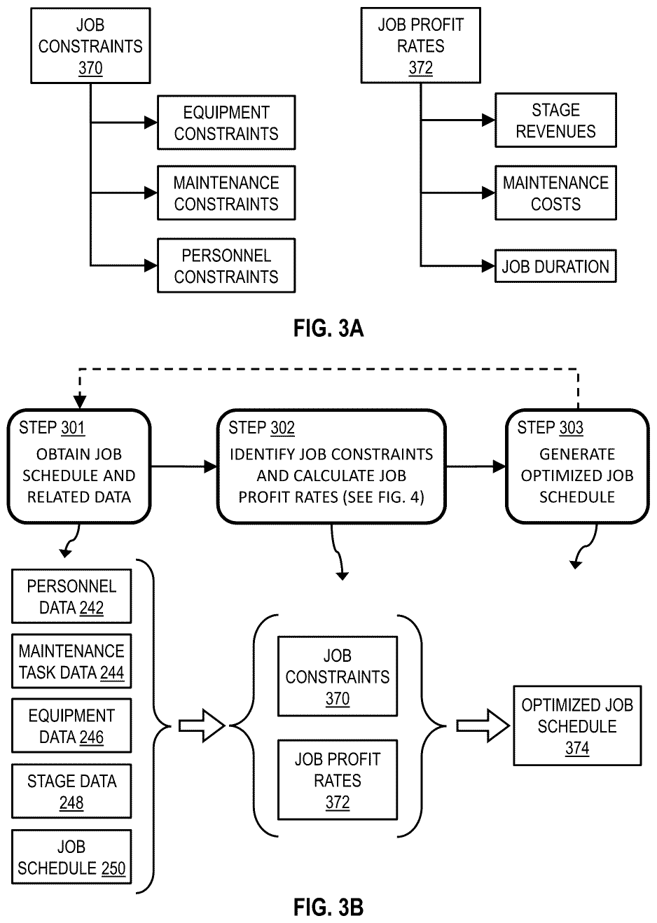

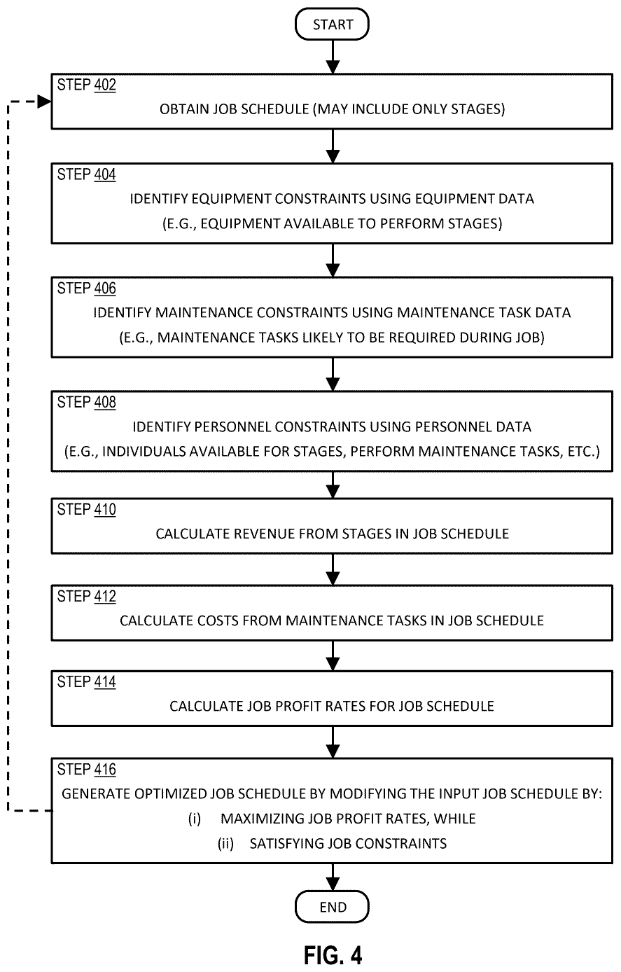

Schedule optimizer 227 is software, executing on one or more information handling systems 126, which may be used to identify job constraints 370 (see description for FIG. 3A), calculate job profit rates 372 (see description for FIG. 3A), and generate an optimized job schedule 374 (see description for FIG. 3B). Schedule optimizer 227 may perform some or all of the processes described in FIG. 3B and FIG. 4.

Database 240 is a data structure that stores information in relational tuples and attributes. In any embodiment, database 240 may be stored on virtual storage volume (across one or more information handling systems 126) and/or directly on a single information handling system 126. Non-limiting examples of database 240 include one or more “tables” each having one or more “rows” (e.g., tuples) and “columns” (e.g., attributes), a structured file for storing tabular data (e.g., a comma-separated value (CSV) file, a tab-separated value (TSV) file, etc.), a relational database management system (RDBMS) (e.g., using Structured Query Language (SQL)), and/or any other data structure capable of storing data. In one or more embodiments, database 240 may be a logical volume for storage of data in any format. In one or more embodiments, any of the data depicted in FIG. 2A may be stored without a database 240 (e.g., directly on storage 134 of one or more information handling systems 126).

Personnel data 242 is data which includes information regarding one or more human workers. Personnel data 242 may include one or more person entries 252, each of which may include information relating to an individual person. Specifically, each person entry 252 may include:

A person identifier (e.g., a unique alphanumeric string associated with the person, an employee ID, username, etc.).

Personal information of the person (e.g., given name(s), family name(s), date of birth, etc.).

The work position and/or title (of the person) in an organization (e.g., for their employer).

The work schedule of the individual (e.g., the planned dates and times at which the individual is present and able to fulfill the duties of their position) and when they are entitled to overtime pay, as an example, which may be used for cost and/or profit calculations.

The person's capabilities (e.g., their qualifications, occupational licenses, experience in various positions, and skillset). In one or more embodiments, the person capabilities include information regarding the person's ability to perform one or more maintenance tasks (specified in a task entry 254), work with various equipment (specified in equipment data 246), and aid in the operation of one or more stages (specified in stage data 248).

Maintenance task data 244 is data which includes information regarding one or more maintenance tasks. Maintenance task data 244 may include one or more task entries 254, each of which may include information relating to an individual task. Specifically, each task entry 254 may include:

A task identifier (e.g., a unique alphanumeric string associated with the task).

A description of the task (e.g., in readable text for a human).

A task cost which estimates the monetary loss to perform the task. Task costs may include the cost of a replacement component (i.e., component cost), the remaining value of the component being replaced, the time to perform the task, the time to procure a new component, and/or any other monetarily quantifiable aspect of the task.

Task requirements which identify constraints to perform the task. Task requirements may be categorized into distinct types, such as:

Task personnel, which may specify the number of people required to perform the task and the minimum qualifications for each of those persons.

Task equipment, specifying which equipment is required to perform the task (e.g., replacement components, tools, other equipment, etc.).

A task duration which estimates the amount of time required to perform the task.

Equipment data 246 is data which includes information regarding one or more pieces of equipment (e.g., pumps 120). Equipment data 246 may include one or more equipment data entries 256, each of which may include information relating to a single piece of equipment (e.g., a pump 120, a tank 118, a vehicle, a tool, a motor, etc.). Specifically, each equipment data entry 256 may include:

An equipment identifier (e.g., a unique alphanumeric string associated with the equipment).

Equipment capabilities (e.g., flow rate capacity, volumetric capacity, energy capacity, power output, operating temperatures, linear speed, rotation speed, power requirements, operating modes, and/or any other specification of a piece of equipment).

Component data 262, which may include one or more component data entries 264, uniquely associated with one or more corresponding components of the piece of equipment (associated with equipment data entry 256).

Component data entry 264 is data which includes information relating to a single component for a piece of equipment (associated with the equipment data entry 256 for the component data 262). Non-limiting examples of a component include a valve, a seal, a bolt, a filter, a drill bit, a cog, a battery, a belt, a chain, and/or another part of a larger machine which may be repaired or replaced. In one or more embodiments, component data entries 264 may be created for components that are perishable, consumable, experience wear, and/or otherwise require replacement or repair. Component data entry 264 may include:

A component identifier (e.g., a unique alphanumeric string associated with the component).

The expected life of the component (e.g., the maximum projected useful life of the component, which may be measured in duration and/or usage).

The measured use of the component, as tracked through use of the larger equipment. Measured use may be measured by usage duration (e.g., 20 minutes, 3,000 hours, etc.) and/or individual specific properties of the usage (e.g., cumulative flow rate for a component of a pump 120, number of rotations for a motor in a centrifuge, etc.).

The remaining life of the component, which may be calculated by subtracting measured use from expected life. Like expected life and measured use, remaining life may be measured in time and/or some property of usage.

The component availability, which may specify the quantity of the components available in possession (e.g., spares), the quantity available for purchase, and/or the time to receive the component (if purchased).

One or more task identifiers for maintenance tasks which may be associated with the component (e.g., a replacement task, a cleaning task, an inspection task, etc.). In turn, those task identifiers may be used to identify the associated task cost in the matching task entry 254 (e.g., the cost of time to replace a valve in a pump 120).

Further, in one or more embodiments, component data entry 264 may further include, or otherwise be associated with, additional data which may be retrieved from other sources, variable based on other factors, and/or calculated using other data within component data entry 264. Such additional data may include:

A component cost, which specifies the monetary expense of the component at the time the component was purchased.

The remaining value of the component, which specifies the current monetary value of the component when accounting for the remaining life of the component. As an example, if a motor shaft costs $100, is rated for 25,000 hours of use, and has been used for 20,000 hours, the remaining value of the motor shaft is $20 (i.e., (1−(20,000/25,000))×$100=$20).

A maximum replacement value of the component, which specifies the monetary expense to obtain a new component, at the currently available price. In one or more embodiments, equipment data 246 may regularly update the maximum replacement value and/or query the data from an external source (e.g., a supplier) to obtain the maximum replacement value.

A remaining life threshold, which specifies the minimum remaining life (or remaining value) to continue using the component before replacement. In one or more embodiments, the remaining life threshold may be calculated from a combination of the remaining life, remaining value, component availability, maximum replacement value, and/or associated tasks. As a non-limiting example, the remaining life threshold may specify to use a component until at least 99% of the component's life has been consumed (leaving 1% or less remaining life), if the component is particularly expensive, time consuming to procure, and/or time consuming to replace. Alternatively, a component may have a lower remaining life threshold if the component is cheap, readily available, and easy to replace.

Stage data 248 is data which includes information regarding one or more stages (i.e., an operation in borehole 102). Stage data 248 may include one or more stage entries 258, each of which may include information relating to a single stage. Specifically, each stage entry 258 may include:

A stage identifier, which may be a unique alphanumeric string associated with the stage.

An order, which species placement in a temporal arrangement, with respect to other stage entries 258. As a non-limiting example, an order may be the numeric value “5”, which places the associated stage entry 258 after a stage entry 258 with order “4” (or lower) and before a stage entry 258 with order “6” or higher.

A stage duration (e.g., the estimated time to complete the stage). In one or more embodiments, the stage duration may be specified as a range, and the stage duration may be dependent upon other variable properties (e.g., a flow rate constrained to a range).

Stage properties, which includes the operations (and the requirements of those operations) to complete the stage (e.g., target flow rate, fluid properties, extraction volume, etc.). In one or more embodiments, a “stage” generally, is a one or more related processes in a larger operation (e.g., completed for a job schedule 250).

Revenue, which specifies the estimated monetary income from performing the stage.

Job schedule 250 is data which includes information regarding one or more jobs (e.g., a stage as specified in a stage entry 258, a maintenance task as specified in a task entry 254, etc.). Job schedule 250 may include one or more schedule entries 260, each of which may include information relating to a one or more stages, one or more maintenance tasks, transition periods between stages, and/or any combination thereof. Specifically, each schedule entry 260 may include:

A scheduled time, which specifies the estimated date and time at which the schedule entry will begin. In one or more embodiments, the scheduled times are generated based on the expected duration of each adjacent schedule entry (which do not allow for concurrent operations) and the order required by the stages.

One or more stage identifiers, which may be used to include data from any stage entry 258 associated with the stage identifiers.

One or more task identifiers, which may be used to include data from any task entry 254 associated with the task identifiers.

Input data 251 is data which is any combination (or any subset of combinations of) of any personnel data 242, maintenance task data 244, equipment data 246, stage data 248, and/or job schedule 250. In one or more embodiments, input data 251 may include a combination of subsets of any two or more types of data (e.g., a subset of equipment data 246 and a subset of personnel data 242 may be considered as input data 251).

### FIGS. 3A-3B

FIG. 3A is a diagram of job constraints, job profit rate, and other data components therein.

FIG. 3B is a flowchart of a method for generating an optimized job schedule. All or a portion of the method shown may be performed by one or more components of information handling system 126 (see description for FIGS. 1A-1C), a schedule optimizer 227 (see description for FIG. 2A), or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

Job constraints 370 is data which includes information regarding one or more conditions, requirements, limits, and/or constraints of the operations performed in a job schedule 250. Job constraints 370 may include constraints which may be categorized into distinct types, which may be obtained and/or calculated using corresponding types of data. As a non-limiting example, as depicted in FIG. 3A, job constraints 370 may include equipment constraints (obtained using equipment data 246), maintenance constraints (obtained using maintenance task data 244), and personnel constraints (obtained using personnel data 242). Job constraints 370 may include data specifying any number of constraints regarding the undertaking of any stage and/or maintenance task. Non-limiting examples of job constraints 370 include (i) the order of the stages, (ii) times of day to perform tasks (e.g., to align with personnel work schedules), (iii) the quantity and/or availability of equipment on location, (iv) the remaining life of any component for any equipment (particularly when that remaining life may risk interrupting a stage), and (v) the projected use of equipment, and the availability to perform concurrent maintenance or the requirement to perform sequential maintenance.

Job profit rate 372 is data which includes information regarding the revenue, costs, and job duration for a job schedule 250. Specifically, in one or more embodiments, job profit rate 372 may include (i) stage revenue, providing the expected monetary inflows for each of the stages specified in a job schedule 250, (ii) maintenance costs, providing the expected monetary outflows for each of the tasks specified in a job schedule 250, and (iii) an expected job duration for an associated job schedule 250. In turn, job profit rate 372 may be calculated, as a non-limiting example, by subtracting the sum of maintenance costs from the sum of stage revenue, then dividing by the job duration (e.g., (Σ[revenue]−Σ[costs])/(job duration)).

Optimized job schedule 374 is a job schedule (e.g., job schedule 250) which has been optimized to maximize (or minimize) one or more properties of a provided job schedule 250. In one or more embodiments, optimized job schedule 374 is generated to maximize job profit rates 372 (while satisfying job constraints 370). However, any number of other properties may be optimized, including, as non-limiting examples, minimizing maintenance costs (e.g., without concern for revenue or job duration), minimizing job duration, maximizing flow rate, minimizing the used equipment, and/or any other quantifiable properties of a job schedule 250. In one or more embodiments, optimized job schedule 374 may not be “fully” optimized. That is, there may be too many variables in job schedule 250 such that generating the most optimized job schedule 374 may require burdensome and lengthy calculations. Accordingly, an optimized job schedule 374 may be considered “optimized” when certain criteria are satisfied (e.g., minimal changes between iterations, satisfying a target job profit rate 372, and/or any other requirement).

As depicted in FIG. 3B, a simplified flowchart provides an overview of a process for generating an optimized job schedule. In a simplified form, the process may be broken into three steps, as discussed below. Additional details regarding a process for generating an optimized job schedule may be found in the description of FIG. 4.

In step 301, schedule optimizer 227 obtains a job schedule 250 and queries to obtain other necessary data (e.g., from personnel data 242, maintenance task data 244, equipment data 246, and stage data 248). In one or more embodiments, a job schedule 250 may include only stage data 248, specifying the desired stages to be completed.

In step 302, schedule optimizer 227 identifies job constraints 370 and job profit rate 372 from the data obtained in step 301. Specifically, the data obtained in step 301 may be analyzed, parsed, or otherwise used to extract job constraints 370 and job profit rates 372 using any combination of the data obtained. Step 302 is described in more detail with respect to steps 404-414 of FIG. 4.

In step 303, schedule optimizer 227 generates an optimized job schedule 374. In one or more embodiments, schedule optimizer 227 may iterate through multiple modifications of a job schedule 250 before generating optimized job schedule 374. That is, as a non-limiting example, the generated optimized job schedule 374 may be fed back into the schedule optimizer 227, as the job schedule 250 provided in step 301. In one or more embodiments, generating the optimized job schedule 374 includes reordering maintenance tasks, shifting schedule times for stages, scheduling concurrent maintenance, scheduling sequential maintenance tasks, changing the equipment used, and/or otherwise adjusting any modifiable aspect of a job schedule 250.

### FIG. 4

FIG. 4 is a flowchart of a method for generating an optimized job schedule. All or a portion of the method shown may be performed by one or more components of information handling system 126 (see description for FIGS. 1A-1C), a schedule optimizer 227 (see description for FIG. 2A), or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

In step 402, schedule optimizer 227 obtains input data 251, which may include a job schedule 250 and other data (e.g., from personnel data 242, maintenance task data 244, equipment data 246, and stage data 248). In one or more embodiments, the provided job schedule 250 may include only stage data 248, specifying the desired stages to be completed.

In step 404, schedule optimizer 227 identifies equipment constraints using equipment data 246. In one or more embodiments, schedule optimizer 227 identifies the equipment necessary and available to complete the stages specified in job schedule 250. Then, based on the identified equipment, schedule optimizer 227 analyzes the equipment capabilities and component data for each of the pieces of equipment, to compile the equipment constraints. As a non-limiting example, a stage may specify a required flow rate range for fluids in a borehole 102. In turn, based on the specified flow rate and the equipment available, a minimum number of pumps 120 (e.g., six) may be required to complete a stage, while a maximum number of pumps may also be determined (potentially for use to expedite completion of the stage).

In step 406, schedule optimizer 227 identifies maintenance constraints using maintenance task data 244. In one or more embodiments, schedule optimizer 227 identifies the tasks required to be performed based on the identified equipment constraints (in step 404). That is, the equipment constraints may specify that certain equipment needs maintenance (currently or is projected to need maintenance soon). Further, based on any component data entry 264 for any component of any of the identified equipment, maintenance tasks may be projected based on the planned usage of the equipment.

In step 408, schedule optimizer 227 identifies personnel constraints using personnel data 242. In one or more embodiments, schedule optimizer 227 identifies persons required to be present and/or working to complete the maintenance tasks (identified in step 406) as well as those individuals who need to be present for the specified stages. As a non-limiting example, schedule optimizer 227 may perform a lookup in any of the identified maintenance tasks (from step 406), identify task personnel specifying the required (or recommended) number of people to be present for the specific maintenance task and their respective job titles (or other qualifications). Then, schedule optimizer 227 performs a lookup in personnel data 242 to identify people matching those criteria, who will be available at needed times, and add their work schedules and availability into the personnel constraints.

In step 410, schedule optimizer 227 calculates the revenue from each of the stages specified in job schedule 250. Further, as the intended (and/or projected) duration of the stage is known, a profit rate for each stage may be calculated.

In step 412, schedule optimizer 227 calculates the maintenances costs from the planned maintenance in job schedule 250. In one or more embodiments, schedule optimizer 227 calculates the cost of any one maintenance task by adding the cost of the components (new component added to the equipment), subtracting the remaining the value of any removed component (using the remaining value as a cost), calculating a cost for the amount of the time to complete the task, adding the cost of any consumable products used for the equipment (e.g., lubricants, fuel, etc.), and/or adding any other monetarily quantifiable object or action.

In step 414, schedule optimizer 227 calculates job profit rates 372 using the stage revenue (calculated in step 410) and the maintenance costs (calculated in step 412). In one or more embodiments, schedule optimizer 227 uses the stage duration and task duration, for each of the stages and maintenance tasks specified in the job schedule 250, respectively, to estimate a total duration for the entire job. Then, by summing the revenue, subtracting the costs, and dividing by the total duration, a job profit rate 372 may be calculated.

In step 416, schedule optimizer 227 generates an optimized job schedule 374. In one or more embodiments, schedule optimizer 227 may iterate through multiple modifications of a job schedule 250 before generating optimized job schedule 374. That is, as a non-limiting example, the generated optimized job schedule 374 may be fed back into the schedule optimizer 227, as the job schedule 250 provided in step 402. In one or more embodiments, generating the optimized job schedule 374 includes reordering maintenance tasks, shifting scheduled times for stages, scheduling concurrent maintenance, scheduling sequential maintenance tasks, changing the equipment used, and/or otherwise adjusting any modifiable aspect of a job schedule 250. Generally, to maximize job profit rate 372, schedule optimizer 227 may minimize time between stages (as no revenue is generated during that time), may schedule maintenance tasks to be concurrent with stages (to avoid delaying stages while maintenance is completed), and may minimize waste of components to avoid negating the remaining value of those components. Further, if possible, schedule optimizer 227 may try to expedite the completion of stages to reduce the overall duration of the stage (thereby increasing the job profit rate 372).

In one or more embodiments, optimized job schedule 374 may not be “fully” optimized. That is, there may be too many variables in job schedule 250 such that generating the most optimized job schedule 374 may require burdensome and lengthy calculations. Accordingly, an optimized job schedule 374 may be considered “optimized” when certain criteria are satisfied (e.g., minimal changes between iterations, satisfying a target job profit rate 372, and/or any other requirement).

Further, in one or more embodiments, the method of FIG. 4 may be performed one or more times again during the operations of a job. That is, as new data is available in personnel data 242, maintenance task data 244, equipment data 246, and/or stage data 248, schedule optimizer 227 may be used again to update optimized job schedule 374 to account for the updated data. As a non-limiting example, in the event of an unexpected equipment malfunction, equipment data 246 may be updated to show the piece of equipment is now unavailable. Consequently, any number of optimizations may be made to the previous optimized job schedule 374 to account for the unexpected maintenance required for the malfunctioning equipment.

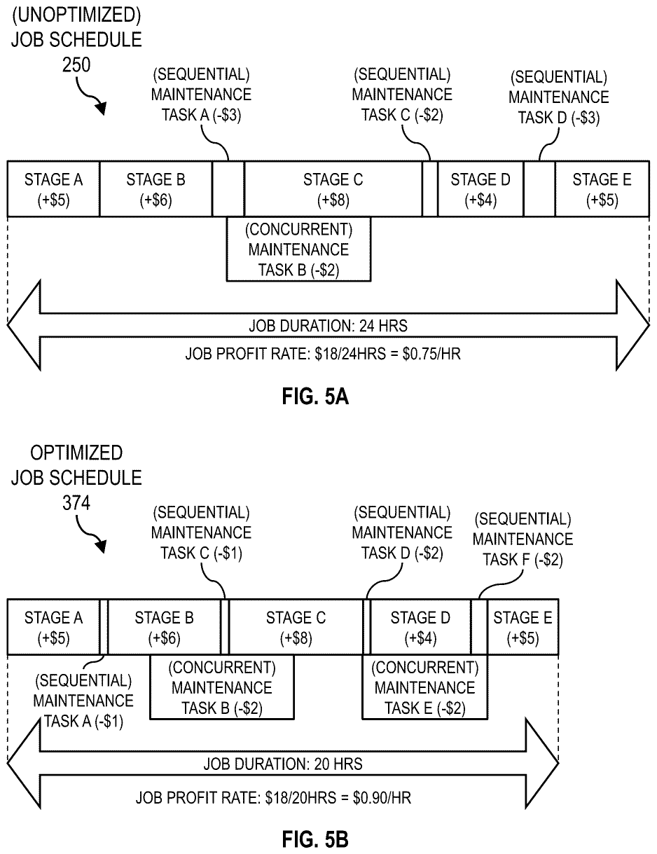

### FIG. 5A

FIG. 5A is a diagram of an example unoptimized job schedule, with corresponding monetary values.

The example of FIG. 5A shows an unoptimized job schedule 250, where the job duration is 24 hours with an estimated profit of $18. Thus, the job profit rate is $0.75/hour for the unoptimized job schedule 250. As can be seen, after the completion of stage A (generating $5), stage B is immediately started without any downtime in between (generating $6). A human-generated job schedule 250 may prioritize the immediate transition between stages to reduce time between the revenue generation.

However, after the completion of stage B, sequential maintenance task A (costing $3) is required to perform substantial maintenance on equipment used in stage B that was also intended for use in stage C. Accordingly, priority is given to certain equipment to try and start stage C sooner, while other less efficient and slower equipment is designated for use in stage C. Thus, the maintenance on some of the desired equipment may be performed as concurrent maintenance task B (costing $2). As a result, stage C (generating $8) starts later than scheduled and has a longer stage duration than initially planned.

After stage C is completed, sequential maintenance task C (costing $2) is performed before stage D is initiated (generating $4). However, after stage D is completed, it is realized that some of the equipment for stage E needs maintenance before stage E can begin. Accordingly, sequential maintenance task D (costing $3) is performed prior to initiating stage E (generating $5).

### FIG. 5B

FIG. 5B is a diagram of an example optimized job schedule, with corresponding monetary values.

The example of FIG. 5B shows an optimized job schedule 374 (of the job schedule 250 shown in FIG. 5A) where the same profit of $18 is generated in a shorter job duration of 20 hours. Thus, the job profit rate is $0.90/hour for the optimized job schedule 374 (20% higher than the unoptimized job schedule 250).

After the completion of stage A (generating $5), instead of going directly into stage B, sequential maintenance task A (costing $1) is performed. This maintenance task allows for equipment (used in stage B) to require less maintenance between stage B and stage C. Consequently, stage B (generating $6) starts at a later scheduled time compared to unoptimized job schedule 250. However, during stage B, concurrent maintenance task B (costing $2) is performed to prepare currently unused equipment which is needed for later stages.

After stage B is completed, sequential maintenance task C (costing $1) is performed. At the time stage C starts, all of the preferred and efficient equipment are available to allow stage C (generating $8) to complete in the shortest duration (e.g., by allowing for the maximum flow rate). Accordingly, stage C completes with a shorter stage duration in optimized job schedule 374 than stage C in the unoptimized job schedule 250.

Further, upon completion of stage C, sequential maintenance task D (costing $2) is performed on the equipment needed for stage D. Additionally, other equipment, normally on standby is used for stage D, allowing for preventative maintenance to be performed on the most efficient equipment needed for stage E. Thus, concurrent maintenance task E (costing $2) begins after the completion of stage C for equipment needed for stage E (but not needed in stage D). Thus, stage D (generating $4) begins after sequential maintenance task D is completed, but while concurrent maintenance task E continues.

After stage D, sequential maintenance task F (costing $2) is performed on equipment used in stage D that is needed for stage E. Further, concurrent maintenance task E continues as equipment for stage E is still being worked on. If only analyzing the current state of the optimized job schedule 374, it may seem that the job is inefficient as no stages are being performed, while multiple maintenance tasks are performed on necessary equipment. However, as the most efficient and speedy equipment is being prepared (by maintenance tasks E and F), stage E (generating $5) is completed faster than in the unoptimized job schedule 250. Thus, the downtime between stages may be increased to allow for a subsequent stage to be completed more quickly.

### Solutions and Improvements

The methods and systems described above are an improvement over the current technology as the methods and systems described herein provide a schedule optimizer that generates an efficient ordering of stages and maintenance tasks in an optimized job schedule. Further, as the schedule optimizer maintains access to continually updated data, the job schedule may be dynamically adjusted and optimized as stages and maintenance are performed. Thus, even when stages and maintenance are not completed as planned, the job can still continue to maintain an optimized ordering of stages and maintenance tasks.

Conventional method for generating a job schedule require using human expertise and intuition to predict and plan the sequential and concurrent operations. Considering the vast complexity of the variables involved, it is impossible for a human to account for every constraint, and such complexity increases the likelihood an error may occur. Accordingly, even the most competently-generated job schedules lack optimization around important criteria.

As is discussed herein, a schedule optimizer is able to consider all of the relevant data to generate an optimized job schedule that accounts for each relevant factor. Further, due to the automated nature of the process, if an unexpected event occurs during the job (e.g., a component breaks prematurely), the relevant data can be updated (e.g., in the equipment data) and the schedule optimizer may be used to generate a new optimized job schedule, provided with the new constraints of the equipment data. Thus, the schedule optimizer not only improves the method for generating an initially optimized job schedule, but further provides dynamic adjustment of jobs, in progress, to ensure an optimized workflow.

### Statements

The systems and methods may comprise any of the various features disclosed herein, comprising one or more of the following statements.

Statement 1. A method for generating an optimized job schedule for a job, comprising obtaining input data, comprising a job schedule specifying a plurality of stages for the job equipment data; maintenance task data identifying a plurality of job constraints using the input data calculating a job profit rate using the input data; generating the optimized job schedule using the plurality of job constraints and the job profit rate.

Statement 2. The method of statement 1, wherein generating the optimized job schedule comprises maximizing the job profit rate.

Statement 3. The method of statement 2, wherein generating the optimized job schedule further comprises satisfying the plurality of job constraints.

Statement 4. The method of statement 3, wherein identifying the plurality of job constraints comprises identifying equipment constraints, in the equipment data, using the plurality of stages.

Statement 5. The method of statement 4, wherein identifying the plurality of job constraints further comprises identifying maintenance constraints, in the maintenance task data, using the equipment constraints.

Statement 6. The method of statement 5, wherein the input data further comprises personnel data.

Statement 7. The method of statement 6, wherein identifying the plurality of job constraints further comprises identifying personnel constraints, in the personnel data, using the maintenance constraints.

Statement 8. The method of statements 3-7, wherein calculating the job profit rate comprises calculating a plurality of maintenance costs associated with the maintenance task data.

Statement 9. The method of statement 8, wherein calculating the job profit rate further comprises calculating a plurality of stage revenues associated with the plurality of stages.

Statement 10. The method of statement 9, wherein calculating the job profit rate is based on the plurality of maintenance costs the plurality of stage revenues; a job duration of the job schedule.

Statement 11. The method of statements 3-10, wherein after generating the optimized job schedule, the method further comprises performing the job.

Statement 12. The method of statement 11, wherein during the job, the method further comprises receiving updated input data identifying a second plurality of job constraints using the updated input data calculating a second job profit rate using the updated input data; generating an updated optimized job schedule using the second plurality of job constraints and the second job profit rate.

Statement 13. The method of statement 12, wherein the updated input data comprises updated equipment data resulting from malfunctioning equipment.

Statement 14. A system for performing a job, comprising an information handling system, wherein the information handling system comprises memory, storing instructions; a processor configured to execute the instructions wherein, when executing the instructions, the processor is configured to perform a method for generating an optimized job schedule for the job, comprising obtaining input data, comprising a job schedule specifying a plurality of stages for the job equipment data; maintenance task data identifying a plurality of job constraints using the input data calculating a job profit rate using the input data; generating the optimized job schedule using the plurality of job constraints and the job profit rate.

Statement 15. The system of statement 14, wherein generating the optimized job schedule comprises maximizing the job profit rate.

Statement 16. The system of statement 15, wherein generating the optimized job schedule further comprises satisfying the plurality of job constraints.

Statement 17. The system of statement 16, wherein identifying the plurality of job constraints comprises identifying equipment constraints, in the equipment data, using the plurality of stages.

Statement 18. The system of statement 17, wherein identifying the plurality of job constraints further comprises identifying maintenance constraints, in the maintenance task data, using the equipment constraints.

Statement 19. The system of statement 18, wherein the input data further comprises personnel data.

Statement 20. The system of statement 19, wherein identifying the plurality of job constraints further comprises identifying personnel constraints, in the personnel data, using the maintenance constraints.

### General Notes

As it is impracticable to disclose every conceivable embodiment of the technology described herein, the figures, examples, and description provided herein disclose only a limited number of potential embodiments. A person of ordinary skill in the relevant art would appreciate that any number of potential variations or modifications may be made to the explicitly disclosed embodiments, and that such alternative embodiments remain within the scope of the broader technology. Accordingly, the scope should be limited only by the attached claims. Further, the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces. Certain technical details, known to those of ordinary skill in the relevant art, may be omitted for brevity and to avoid cluttering the description of the novel aspects.

For further brevity, descriptions of similarly named components may be omitted if a description of that similarly named component exists elsewhere in the application. Accordingly, any component described with respect to a specific figure may be equivalent to one or more similarly named components shown or described in any other figure, and each component incorporates the description of every similarly named component provided in the application (unless explicitly noted otherwise). A description of any component is to be interpreted as an optional embodiment—which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” may be used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for the transmission of data. For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

As used herein, indefinite articles “a” and “an” mean “one or more”. That is, the explicit recitation of “an” element does not preclude the existence of a second element, a third element, etc. Further, definite articles (e.g., “the”, “said”) mean “any one of” (the “one or more” elements) when referring to previously introduced element(s). As an example, there may be “a processor”, where such a recitation does not preclude the existence of any number of other processors. Further, “the processor receives data, and the processor processes data” means “any one of the one or more processors receives data” and “any one of the one or more processors processes data”. It is not required that the same processor both (i) receive data and (ii) process data. Rather, each of the steps (“receive” and “process”) may be performed by different processors.

As used herein, “machine” means any collection of components assembled to form a tool, structure, or other apparatus. A collection of components may be grouped together and referred to as a single ‘machine’ based on the functionality of the machine enabled by the combination of the components. As a non-limiting example, a “car engine” is a machine assembled from the components of an engine block, one or more piston(s), a camshaft, etc. that, when combined, function to convert chemical energy into mechanical energy. Further, a machine may be constructed using one or more other machine(s). As a non-limiting example, an automobile may be an assembly of a car engine, a drivetrain, and a steering system—each an independent machine—but assembled together to form a larger machine, singularly referred to as an “automobile” which functions to provide transportation.

As used herein, “real-time” may be generally understood to relate to a system, apparatus, or method in which a set of input data is available for use within 100 milliseconds (“ms”). Additionally, as used herein, “real-time” may refer to any duration of time to acquire and/or otherwise process data that is sufficiently short enough for a human to believe the data is providing an up-to-date and/or accurate representation of the underlying system. Accordingly, “real-time” may be context specific. As a first non-limiting example, 20 ms (or less) may be the maximum allowable latency to avoid inducing nausea in a human using a virtual reality headset (i.e., providing “real-time” sensory stimulation for motion detected by the inner ear and motion detected by eyesight). As a second non-limiting example, motor vibration data that is displayed on a monitor one second after the vibration occurred may be considered “real-time”. And, as a third non-limiting example, measured movements of Earth's tectonic plates—obtained and processed only once per day—may be considered “real-time”.

What is claimed is:

1. A method for generating an optimized job schedule for a job, comprising:
obtaining input data, comprising:
a job schedule specifying a plurality of stages for the job;
equipment data; and
maintenance task data;
identifying a plurality of job constraints using the input data;
calculating a job profit rate using the input data; and
generating the optimized job schedule using the plurality of job constraints and the job profit rate.

2. The method of claim 1, wherein generating the optimized job schedule comprises:
maximizing the job profit rate.

3. The method of claim 2, wherein generating the optimized job schedule further comprises:
satisfying the plurality of job constraints.

4. The method of claim 3, wherein identifying the plurality of job constraints comprises:
identifying equipment constraints, in the equipment data, using the plurality of stages.

5. The method of claim 4, wherein identifying the plurality of job constraints further comprises:
identifying maintenance constraints, in the maintenance task data, using the equipment constraints.

6. The method of claim 5, wherein the input data further comprises:
personnel data.

7. The method of claim 6, wherein identifying the plurality of job constraints further comprises:
identifying personnel constraints, in the personnel data, using the maintenance constraints.

8. The method of claim 3, wherein calculating the job profit rate comprises:
calculating a plurality of maintenance costs associated with the maintenance task data.

9. The method of claim 8, wherein calculating the job profit rate further comprises:
calculating a plurality of stage revenues associated with the plurality of stages.

10. The method of claim 9, wherein calculating the job profit rate is based on:
the plurality of maintenance costs;
the plurality of stage revenues; and
a job duration of the job schedule.

11. The method of claim 3, wherein after generating the optimized job schedule, the method further comprises:
performing the job.

12. The method of claim 11, wherein during the job, the method further comprises:
receiving updated input data;
identifying a second plurality of job constraints using the updated input data;
calculating a second job profit rate using the updated input data; and
generating an updated optimized job schedule using the second plurality of job constraints
and the second job profit rate.

13. The method of claim 12, wherein the updated input data comprises:
updated equipment data resulting from malfunctioning equipment.

14. A system for performing a job, comprising an information handling system, wherein the information handling system comprises:
memory, storing instructions; and
a processor configured to execute the instructions,
wherein, when executing the instructions, the processor is configured to perform a method for generating an optimized job schedule for the job, comprising:
obtaining input data, comprising:
a job schedule specifying a plurality of stages for the job;
equipment data; and
maintenance task data;
identifying a plurality of job constraints using the input data;
calculating a job profit rate using the input data; and
generating the optimized job schedule using the plurality of job constraints and the job profit rate.

15. The system of claim 14, wherein generating the optimized job schedule comprises:
maximizing the job profit rate.

16. The system of claim 15, wherein generating the optimized job schedule further comprises:
satisfying the plurality of job constraints.

17. The system of claim 16, wherein identifying the plurality of job constraints comprises:
identifying equipment constraints, in the equipment data, using the plurality of stages.

18. The system of claim 17, wherein identifying the plurality of job constraints further comprises:
identifying maintenance constraints, in the maintenance task data, using the equipment constraints.

19. The system of claim 18, wherein the input data further comprises:
personnel data.

20. The system of claim 19, wherein identifying the plurality of job constraints further comprises:
identifying personnel constraints, in the personnel data, using the maintenance constraints.
